(19) United States
(12) Patent Application Publication
(10) Pub. No.: US 2015/0077352 A1
(43) Pub. Date: Mar. 19, 2015

(54) Multi-Touch Virtual Mouse

(71) Applicant: Lili Michael Ma, Shanghai (CN)

(72) Inventor: Lili Michael Ma, Shanghai (CN)

(21) Appl. No.: 14/123,521

(22) PCT Filed: Sep. 13, 2013
(86) PCT No.: PCT/CN2013/083438

§ 371 Date: Dec. 4, 2013

(51) Int. Cl. G06F 3/0354

(52) U.S. Cl. CPC G06F 3/03547; G06F 2203/0336
USPC 345/173

(57) ABSTRACT

In accordance with some embodiments, a touch input device such as a touch screen or track pad or touch pad may be operated in mouse mode by touching the screen simultaneously with more than one finger. In one embodiment, three fingers may be utilized. The three fingers in one embodiment may be the thumb, together with the index finger and the middle finger. Then the index finger and the middle finger may be used to left or right click to enter a virtual mouse command.

### BACKGROUND

This relates generally to the use of mouse commands to control a touch screen cursor.

In conventional processor-based systems, such as laptop computers, desktop computers, cellular telephones, media playing devices such as game devices and other such devices, touch screen entered mouse commands provide an alternative to the use of a keyboard or mouse entered cursor command. For example, mouse commands may be used to move a cursor in order to make a selection on a display screen. Conventionally a mouse is held in the user's hand and movement of the mouse moves the cursor. Clicking on a button on the mouse enables the selection of a displayed object overlaid by the cursor.

In some cases, mobile users may find that use of a mouse is awkward because it requires carrying an additional device which could be larger than the actual processor-based device such as cellular telephone. Also, with small screen devices, such as those found on cellular telephones, there may not be enough screen space to select some smaller features displayed on the screen. Another problem is that it may be difficult for the user to accurately place the mouse cursor at a particular location in the case of small icon buttons or links on a display screen.

### BRIEF DESCRIPTION OF THE DRAWINGS

Some embodiments are described with respect to the following figures:

FIG. 1 is a top view of the user's right hand on a display screen according to one embodiment;

FIG. 2 is a top view of a user's left hand on a display screen;

FIG. 3 shows a user's left hand, left clicking on the display screen;

FIG. 4 shows a user's hand right clicking on the display screen;

FIG. 5 is a top view showing a one-finger mode of the user's hand on the display screen;

FIG. 6 is a top view showing a two finger mode;

FIG. 7 is a top view showing another two finger mode;

FIG. 8 is a portion of a flow chart for one embodiment;

FIG. 9 is a continuation of the flow chart of FIG. 6; and

FIG. 10 is a schematic depiction for one embodiment.

### DETAILED DESCRIPTION

In accordance with some embodiments, a touch input device such as a touch screen may be operated in mouse mode by touching the screen simultaneously with more than one finger. In one embodiment, three fingers may be utilized. The three fingers in one embodiment may be the thumb, together with the index finger and the middle finger. Then the index finger and the middle finger may be used to left or right click to enter a virtual mouse command.

As used herein a touch input device is a multi-touch input device that detects multiple fingers touching the input device.

In some embodiments, a system may detect simultaneous touching by multiple fingers on a touch input device. In the case of a three finger screen touch command, the system may determine whether the left or the right hand is on the device and the relative positions of the three fingers. One way this can be done is to resolve the nature of a triangle defined by the three points of contact and particularly its shape and from this, determine whether the user's left or right hand is on the device. This hand identification may be important in determining whether a left click or a right click is signaled. A left click or right click may be signaled in one embodiment by tapping either the index or middle finger on the screen depending on which of the left or right hands is used. In one embodiment, the left hand's index finger is in the right position, and the right hand's index finger is in the left position. Both of them are left clicking. So hand identification can be important is some embodiments.

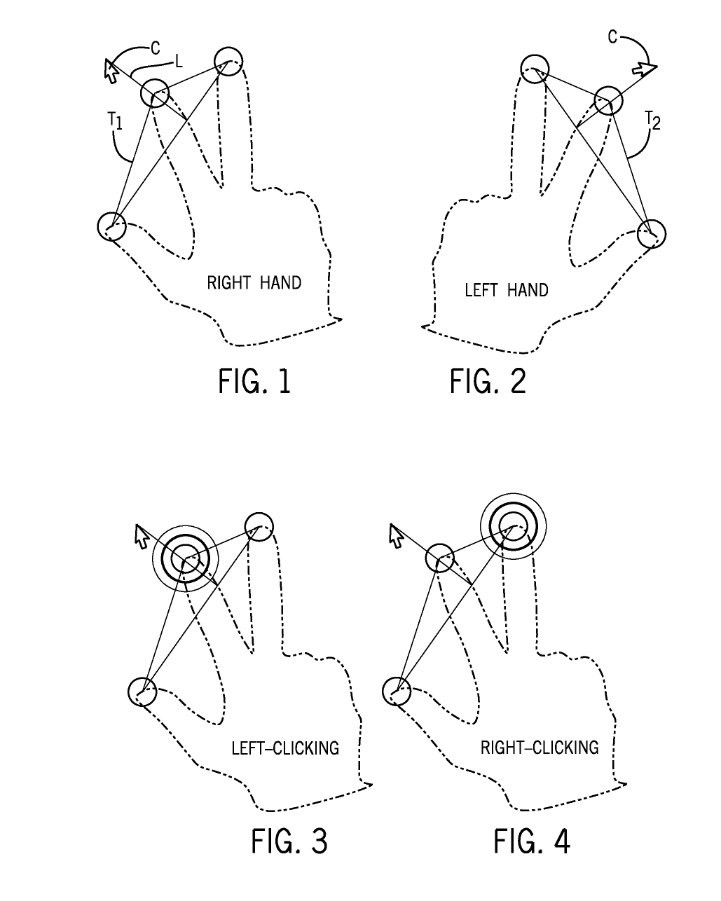

Thus referring to FIG. 1, a touch input device is overlaid by the user's right hand. The index finger is in the middle, the middle finger is on the right and the thumb is on the left—forming a particular orientation and shape of a triangle T1. The nature of that triangle may be resolved based on shape and orientation to determine if it is the three fingers of the user's right or left hand on the screen. A mouse image may be automatically generated on screen under the user's hand in response to detection of contact.

There are many different techniques that may be used to identify whether the left or the right hand is touching the screen. For example the triangle formed by the three points of contact, in some embodiments, may be analyzed to determine whether the longest leg of the triangle is angled to the right or the left. If it is angled to the right, it would indicate left hand contact and the left hand mouse mode may be implemented. If it is angled to the left, then a right hand contact may be identified and a right hand mouse mode may be implemented. Another example would be to determine whether the middle or index finger is to the left or the right of the longest leg of the triangle. Those skilled in the art can appreciate a variety of other techniques.

The cursor may be automatically caused to appear, in a touch screen embodiment, in response to detection of appropriate multi-finger contact. In one three finger embodiment, the triangle T1 has vertices determined by the thumb, index and middle finger contact points. The cursor C, may then be placed on the line L that is perpendicular to the longest side of the triangle and which passes through the middle vertex. The distance along the line away from the middle vertex may be subject to user selection or may be a default value.

Similarly as shown in FIG. 2, the user's left hand is on the input device with the middle finger on the left, the thumb on the right and the index finger in the middle. Again, the shape of the triangle T2 that is formed may be resolved to determine that it is the left or right hand of the user on the input device.

From the position shown in FIG. 1, the cursor may be moved, for example, by sliding the entire hand (or at least one finger, in this case, the index finger), along the device in order to move the cursor as desired. In one embodiment, the cursor may be displayed automatically near the index finger as indicated by C. The cursor may also be caused to appear automatically near one finger when the three point contact is detected.

The multiple finger mouse simulation mode terminates when there is no touch event within a predetermined time. Moreover in some embodiments, the fingers must remain on the screen for a threshold time in order to implement the multiple finger mouse simulation mode.

When the user moves or rotates all three fingers on the touch input device, the cursor C moves accordingly. When the index finger taps the touch input device, a left clicking event is detected. And if the middle finger taps the input device, in the case of either the right or left hand in one embodiment, a right click is detected. Other embodiments may also be utilized wherein the leftmost finger tapping on the screen indicates a left click and the rightmost finger of the index and middle fingers, tapping on the screen, indicates a right click. This is shown in FIGS. 3 and 4.

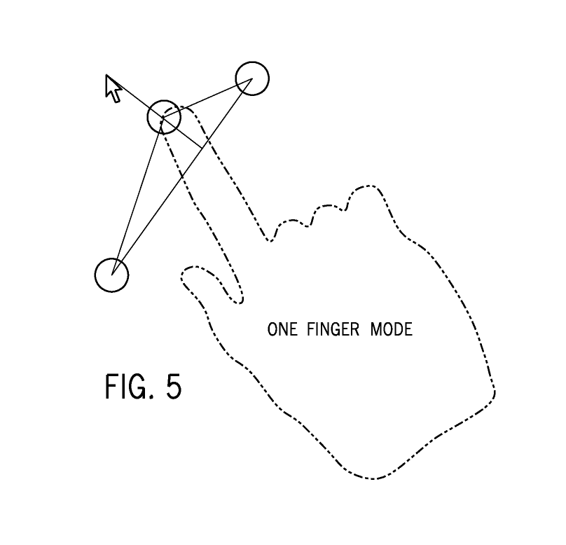

In one embodiment, shown in FIG. 5, if two of three fingers are removed from input device contact and one finger keeps touching the input device, the system enters a one finger mouse simulation mode. The single touching finger is treated as the index finger as in the three fingers mouse simulation mode. The one finger in contact with the screen may tap the device and such tapping may be treated as a left clicking event on the cursor. A one finger mouse simulation mode may be simpler for end users to utilize in some cases.

In some embodiments, the multiple finger mouse simulation mode may be implemented by the touch controller or an embedded service hub. Once the touch controller or embedded service hub detects entry into the mouse simulation mode, touch events will not be reported to the host until the system exits the mouse simulation mode. In other implementations, the touch events can still be reported to the host. The simulated mouse events may be reported to the host by the touch controller or the embedded service hub.

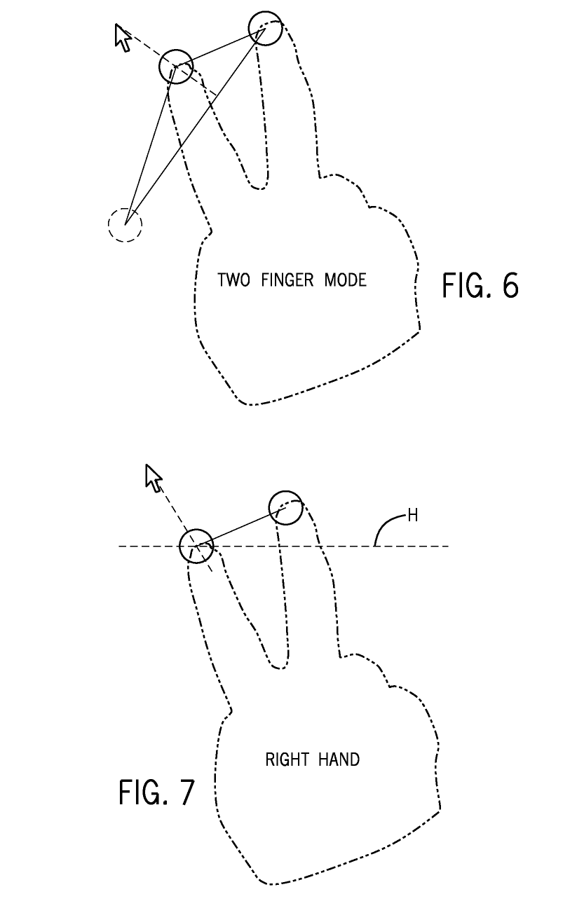

As an example of a two finger mode, shown in FIG. 6, two fingers such as the index and middle finger may be used to move the cursor. The cursor mode may be implemented by initial three finger contact with thumb contact indicated by the dashed circle, followed by lifting the thumb and moving only the two fingers. When the thumb is down, the system can resolve whether or not it is the left or the right hand as described previously.

As another example of a two finger mode, shown in FIG. 7, the index and middle finger are used in a two finger mode. Whether the longer finger (relative to the dashed horizontal line H) is on the left or the right may be used to indicate whether the left or the right hand is in contact with the input device.

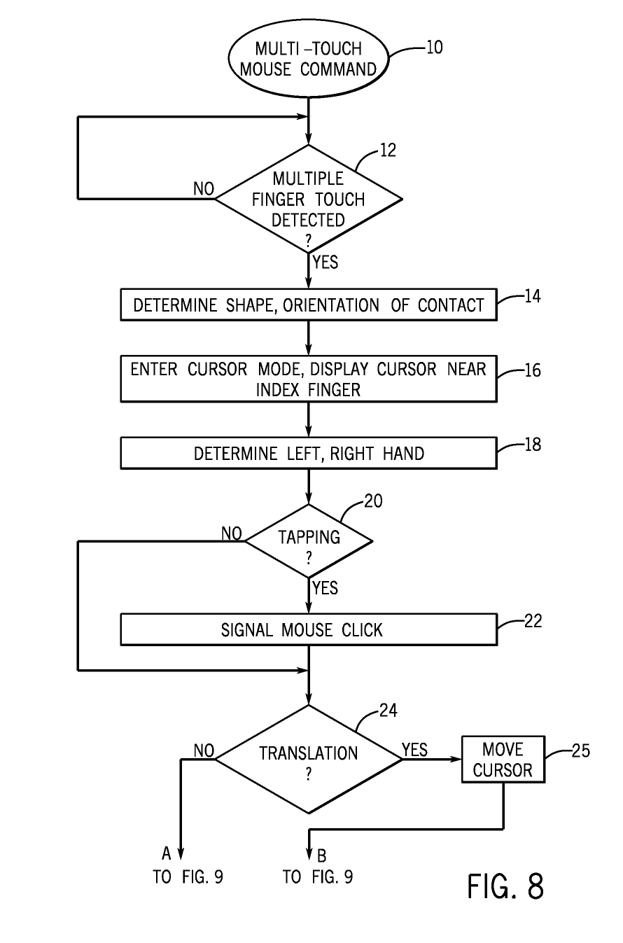

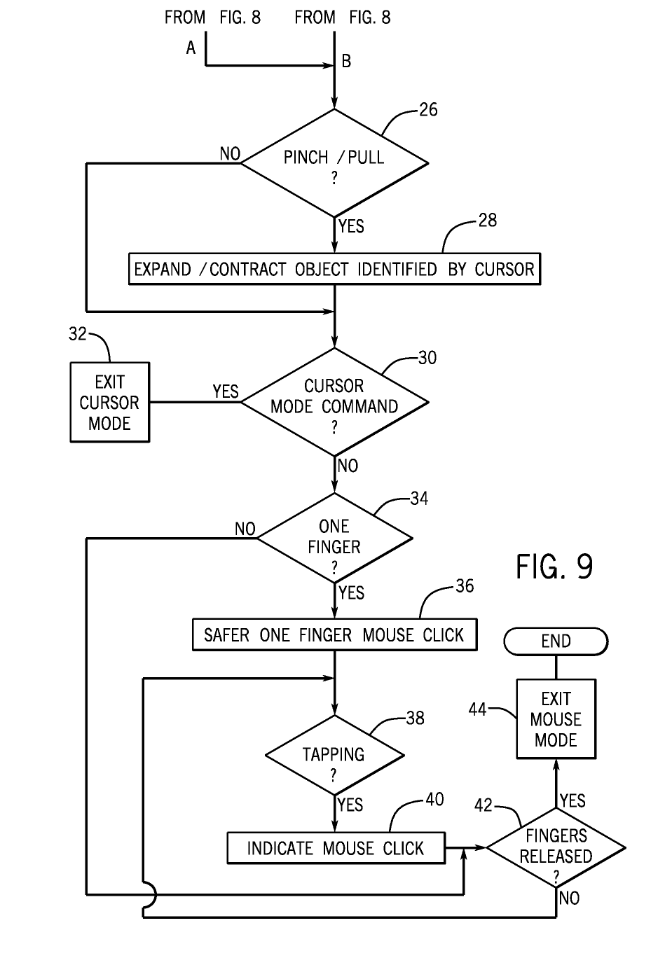

Thus, referring to FIG. 8, a sequence 10 may be implemented in software, firmware and/or hardware. In software and firmware embodiments, it may be implemented by computer executed instructions stored in one or more non-transitory computer readable media such as magnetic, optical or semiconductor storages.

In one embodiment, the sequence 10 begins by detecting whether multiple fingers are touching a touch input device as indicated in block 12. If so, the shape and orientation of multiple finger contact is determined as indicated in block 14. Next, the sequence enters cursor mode (block 16). In cursor mode all inputs are resolved based on cursor position not finger position. Thus, what matters for a mouse click is where the cursor is located not where a tapping finger is located. Also, in the cursor mode, a cursor is automatically displayed on a display screen. In a touch screen embodiment it may be displayed near but not under a finger, such as the index finger. Then the system determines whether the right or left hand is touching the screen as indicated in block 18. A cursor may automatically be displayed near a particular finger.

Next a check at diamond 20 determines whether one of the middle or index fingers is tapping the screen. If so, the appropriate mouse click is signaled as indicated in block 22. Besides the left clicking and right clicking, there are other mouse commands such as double click, mouse over, left/right click, left/right button down/up, mouse wheel, mouse moves, and move out, which may be signaled by finger topping and/or hand/finger position on the screen in some embodiments.

Thereafter, a check at diamond 24 determines whether the fingers touching the screen have translated. If so, the cursor is translated as indicated in block 25.

In some embodiments, as shown in FIG. 9, other conventional finger based input commands can be signaled. For example, swiping or pinching and pulling of two fingers can be used, as conventionally done in various phone and tablet applications. In the example illustrated in FIG. 9, a pinch or pull may be detected at diamond 26. If this is detected, the object identified by the cursor is expanded or contracted rather than the object directly under the finger motion (block 28). The pinch and pull for example, may be signaled by increasing or decreasing the distance between the thumb and forefinger.

Next a check at diamond 30 whether there is a cursor mode command. A cursor mode command may be a command to immediately exit the cursor mode. It may be signaled by simply removing finger contact for a period of time or it may be signaled by a special form of finger contact such as by contacting the screen with a fourth finger, including either the ring finger or the small finger. If a cursor exit command is received then the cursor mode may be exited at block 32.

If no such cursor mode command is received, then a check at diamond 34 determines whether the one finger mouse mode is indicated. The one finger mouse mode may be implemented (block 36) by transitioning from the three finger contact mode or the two finger contact mode and going to only one finger. The system knows it is in cursor mode because of the three finger contact and when all but one finger is lifted from the device, it simply enters the one finger mouse mode as indicated in block 36. In the one finger mouse mode, the cursor is moved in the same way (by one finger contact) such as the finger contact and tapping of that same finger also signals selection of whatever object is depicted under the cursor (as opposed to whatever object is under the finger).

In the one finger mode, the tapping is detected in diamond 38. And a mouse click is indicated in block 40. If all the fingers are released for a given period of time as determined in diamond 42, then the mouse mode is exited as indicated in block 44. Otherwise the flow continues to iterate back to check for the one finger mouse mode commands.

While a limited number of commands are indicated herein, commands may be any type of finger command. In some embodiments, even in the cursor mode, non-cursor commands may be received and in other embodiments, only cursor-type commands or mouse-type commands may be received in the cursor mode.

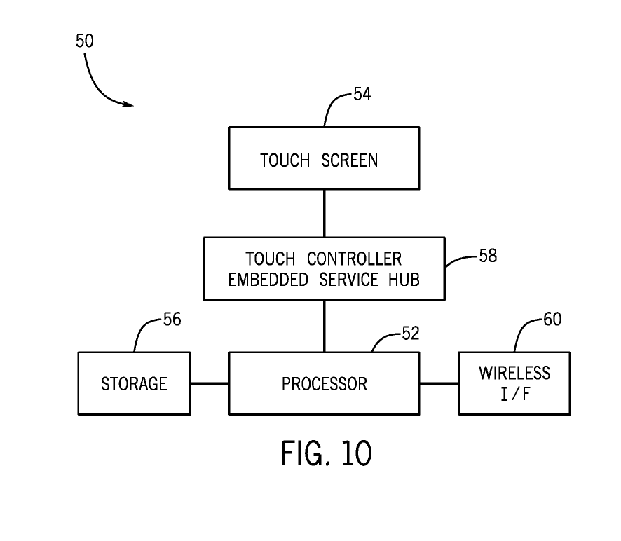

Referring to FIG. 10, a processor-based device 50 may include a processor 52 coupled to storage 56. The device 50 may be a tablet or cellular telephone in some embodiments. A touch controller or embedded service hub 58 may be coupled to the processor 52. A multi-touch input device pad 54 is also coupled to the touch controller 58. In some embodiments, a wireless interface 60 may be coupled to the processor 52. In some cases, the touch controller 58 may implement the sequence as shown in FIGS. 8 and 9.

An embedded service hub is a sensor hub in Windows 8 or in in any other operating system environment. One microcontroller may connect all sensors to one system on a chip and an application processor so that the sensor hub can handle the detection of finger contact and the implementation of the mouse cursor mode in some embodiments.

In some embodiments, a training mode may allow a user to select which fingers and the number of fingers that may be used to enter a mouse based cursor mode. For example, the system may prompt the user to position the user's fingers on the display in a way in which the user wants so as to signal a mouse cursor mode. Then this pattern is recorded and when it is subsequently detected, the mouse cursor mode is entered. For example the user could then touch on the screen using the index, thumb and middle fingers. Alternatively the user could touch with the index, middle and ring finger. And still another alternative, two fingers may contact the screen together with part of the palm of the same hand. Many other variations are also possible.

In some embodiments, the sequence depicted in FIGS. 8 and 9 may be implemented in software or firmware which may resident within the embedded service hub, the touch controller, a general purpose processor, a specialty processor, or an application run by an operating system, to mention a few examples.

In some embodiments, the recognition of the mouse cursor mode via finger contact may be confirmed by providing a visual indication on a display. In one embodiment, an image of a mouse may be caused to appear under the user's fingers as if an actual mouse were present. In one embodiment that mouse depiction may be in phantom or in a lighter depiction so as not to obscure the underlying material.

The following clauses and or examples pertain to further embodiments:

One example embodiment may be a method comprising detecting contact on a touch input device including at least two fingers, in response to said detection, entering a cursor mode, displaying a cursor, and controlling cursor position based on movement of one or more of said fingers. The method may also include wherein said device is a touch screen and displaying said cursor near one of said fingers. The method may also include detecting contact by at least three fingers. The method may also include wherein said finger contacts include a thumb contact. The method may also include determining whether the fingers belong to a user's left or right hand. The method may also include resolving mouse-type commands based on whether the left or right hand was determined to contact the device. The method may also include causing the cursor to move with a finger without being covered by said finger.

Another example embodiment may be an apparatus comprising means for detecting multiple finger contact on a touch input device, means for receiving a selection of an object displayed on a display, and means for selecting an object based on cursor not finger location. The apparatus may include means for entering cursor mode in response to detecting. The apparatus may include means for displaying a cursor in response to said detecting. The apparatus may include means for controlling cursor position based on movement of one or more fingers. The apparatus may include means for displaying said cursor near one of said fingers. The apparatus may include means for detecting contact by at least three fingers. The apparatus may include means for storing instructions to implement a sequence wherein said finger contact include a thumb contact. The apparatus may include means for storing instructions to implement a sequence including determining whether the fingers belong to a user's left or right hand. The apparatus may include means for storing instructions to implement a sequence including resolving mouse-type commands based on whether the left or right hand was determined to contact the device. The apparatus may include means for causing the cursor to move with a finger without being covered by said finger.

In another example embodiment an apparatus comprising a processor, a touch screen coupled to said processor, and a device to detect contact on a touch screen including at least two fingers, and in response to said detection, enter a cursor mode, display a cursor and control cursor position based on movement of one or more of said fingers. The apparatus may include said device to display said cursor near one of said fingers. The apparatus may include said device to detect screen contact by at least three fingers. The apparatus may include wherein said finger contact includes a thumb contact. The apparatus may include said device to determine whether the fingers belong to a user's left or right hand. The apparatus may include said device to resolve mouse-type commands based on whether the left or right hand was determined to contact the screen. The device may include said device to cause the cursor to move with screen finger movement without being covered by said finger.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. A method comprising:
detecting contact on a touch input device including at least two fingers;
in response to said detection, entering a cursor mode;
displaying a cursor; and
controlling cursor position based on movement of one or more fingers.

2. The method of claim 1 including controlling cursor position based on movement of one or more of said at least two fingers.

3. The method of claim 1 wherein said device is a touch screen and displaying said cursor near one of said fingers.

4. The method of claim 1 including detecting contact by at least three fingers.

5. The method of claim 4 wherein said finger contacts include a thumb contact.

6. The method of claim 4 including determining whether the fingers belong to a user's left or right hand.

7. The method of claim 6 including resolving mouse-type commands based on whether the left or right hand was determined to contact the device.

8. The method of claim 1 including causing the cursor to move with a finger without being covered by said finger.

9. An apparatus comprising:
means for detecting multiple finger contact on a touch input device;
means for receiving a selection of an object displayed on a display; and
means for selecting an object based on cursor not finger location.

10. The apparatus of claim 9 including means for entering cursor mode in response to detecting.

11. The apparatus of claim 9 including means for displaying a cursor in response to said detecting.

12. The apparatus of claim 11 including means for controlling cursor position based on movement of one or more fingers.

13. The apparatus of claim 11 including means for displaying said cursor near one of said fingers.

14. The apparatus of claim 9 including means for detecting contact by at least three fingers.

15. The apparatus of claim 14 including means for storing instructions to implement a sequence wherein said finger contact include a thumb contact.

16. The apparatus of claim 14 including means for storing instructions to implement a sequence including determining whether the fingers belong to a user's left or right hand.

17. The apparatus of claim 9 including means for storing instructions to implement a sequence including resolving mouse-type commands based on whether the left or right hand was determined to contact the device.

18. The apparatus of claim 11 including means for causing the cursor to move with a finger without being covered by said finger.

19. An apparatus comprising:
a processor;
a touch screen coupled to said processor; and
a device to detect contact on a touch screen including at least two fingers, and in response to said detection, enter a cursor mode, display a cursor and control cursor position based on movement of one or more of said fingers.

20. The apparatus of claim 19, said device to display said cursor near one of said fingers.

21. The apparatus of claim 19, said device to detect screen contact by at least three fingers.

22. The apparatus of claim 21, wherein said finger contact includes a thumb contact.

23. The apparatus of claim 19, said device to determine whether the fingers belong to a user's left or right hand.

24. The apparatus of claim 19, said device to resolve mouse-type commands based on whether the left or right hand was determined to contact the screen.

25. The apparatus of claim 19, said device to cause the cursor to move with screen finger movement without being covered by said finger.
